(19) United States
(12) Patent Application Publication
(10) Pub. No.: US 2013/0121203 A1
(43) Pub. Date: May 16, 2013

(54) Apparatus and Method of Reporting Power Headroom in Wireless Communication System

(71) Applicants: Sung Hoon Jung, Gyeonggi-do (KR); Sung Duck Chun, Gyeonggi-do (KR); Seung June Yi, Gyeonggi-do (KR); Young Dae Lee, Gyeonggi-do (KR); Sung Jun Park, Gyeonggi-do (KR)

(72) Inventors: Sung Hoon Jung, Gyeonggi-do (KR); Sung Duck Chun, Gyeonggi-do (KR); Seung June Yi, Gyeonggi-do (KR); Young Dae Lee, Gyeonggi-do (KR); Sung Jun Park, Gyeonggi-do (KR)

(73) Assignee: LG ELECTRONICS INC., Seoul (KR)

(21) Appl. No.: 13/806,012

(22) PCT Filed: Sep. 30, 2011
(86) PCT No.: PCT/KR11/07215

§ 371 Date: Dec. 20, 2012

Related U.S. Application Data
(60) Provisional application No. 61/388,583, filed on Sep. 30, 2010.

(51) Int. Cl. H04W 52/30

(52) U.S. Cl. CPC H04W 52/30
USPC 370/252

(57) ABSTRACT

A method and apparatus of reporting a power headroom in a wireless communication system is provided. A user equipment determines a power headroom based on a configured transmit power and transmits a power headroom report to a base station. The power headroom report includes a power headroom level indicating the power headroom and a backoff indicator indicating whether the user equipment applies power backoff due to power management.

### TECHNICAL FIELD

The present invention relates to wireless communications, and more particularly, to a method and apparatus of reporting a power headroom in a wireless communication system.

### BACKGROUND ART

3rd generation partnership project (3GPP) long term evolution (LTE) is an improved version of a universal mobile telecommunication system (UMTS) and is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas. In recent years, there is an ongoing discussion on 3GPP LTE-advanced (LTE-A) that is an evolution of the 3GPP LTE.

It is important to properly regulate transmit power when a user equipment (UE) transmits data to a base station (BS). If the transmit power is too low, the BS may not be able to correctly receive the data. If the transmit power is too high, it may cause interference to another UE. Therefore, the BS regulates the transmit power of the UE in a wireless communication system.

In order for the BS to regulate the transmit power of the UE, it is required to acquire essential information from the UE. A representative example thereof is a power headroom. The power headroom implies power that can be further used in addition to the transmit power currently used by the UE. The power headroom may imply a difference between maximum transmit power of the UE and the currently used transmit power.

When the BS receives the power headroom from the UE, the BS determines transmit power to be used in next UE's uplink transmission on the basis of the power headroom. The determined transmit power is indicated by a resource block size and a modulation and coding scheme (MCS).

A heterogeneous system in which a plurality of radio access technologies (RATs) coexist has recently been introduced. Therefore, transmit power regulation considering the conventional signal RAT may not enough to obtain required throughput.

### DISCLOSURE OF INVENTION

### Technical Problem

The present invention provides a method and apparatus of transmitting a power headroom report in a wireless communication system to indicate whether power backoff for uplink transmission is applied.

### Solution to Problem

In an aspect, a method of reporting a power headroom in a wireless communication system is provided. The method includes determining, by a user equipment, a power headroom based on a configured transmit power, and transmitting, by the user equipment, a power headroom report to a base station, the power headroom report including a power headroom level indicating the power headroom and a backoff indicator indicating whether the user equipment applies power backoff due to power management.

The power headroom report may further include a transmit power field indicating the configured transmit power.

The backoff indicator may be set to one if the transmit power field would have had a different value if no power backoff due to power management had been applied.

In another aspect, an apparatus of reporting a power headroom in a wireless communication system is provided. The apparatus includes a radio frequency unit configured to transmit and receive a radio signal, and a processor operatively coupled with the radio frequency unit and configured to determine a power headroom based on a configured transmit power, and transmit a power headroom report to a base station, the power headroom report including a power headroom level indicating the power headroom and a backoff indicator indicating whether the user equipment applies power backoff due to power management.

### Advantageous Effects of Invention

A base station can recognize whether a user equipment arbitrarily regulates the transmit power, and can more accurately know about available transmit power that can be used by the user equipment in uplink transmission. Therefore, improved link adaptation can be provided to the user equipment.

### BRIEF DESCRIPTION OF DRAWINGS

FIG. 1 shows a wireless communication system to which the present invention is applied.

FIG. 2 is a diagram showing a radio protocol architecture for a user plane.

FIG. 3 is a diagram showing a radio protocol architecture for a control plane.

FIG. 4 shows an example of multiple carriers.

FIG. 5 shows a second-layer structure of a BS for multiple carriers.

FIG. 6 shows a second-layer structure of a UE for multiple carriers.

FIG. 7 shows a structure of a MAC PDU in 3GPP LTE.

FIG. 8 is a flowchart showing a power headroom reporting method according to an embodiment of the present invention.

FIG. 9 is an example of MAC CE for PHR according to an embodiment of the present invention.

FIG. 10 is a block diagram showing an apparatus for implementing an embodiment of the present invention.

### MODE FOR THE INVENTION

FIG. 1 shows a wireless communication system to which the present invention is applied. A wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

A radio interface between the UE and the BS is called a Uu interface. Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

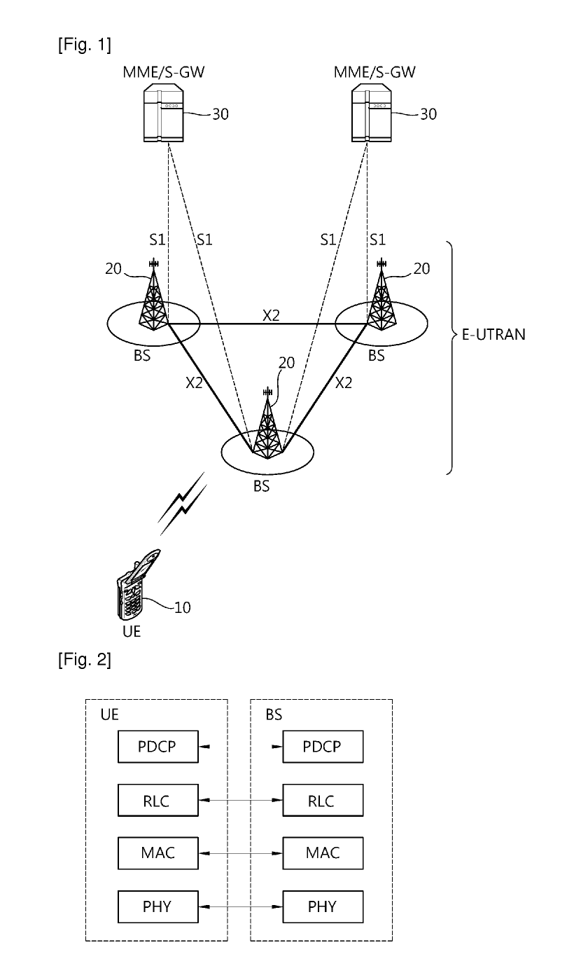

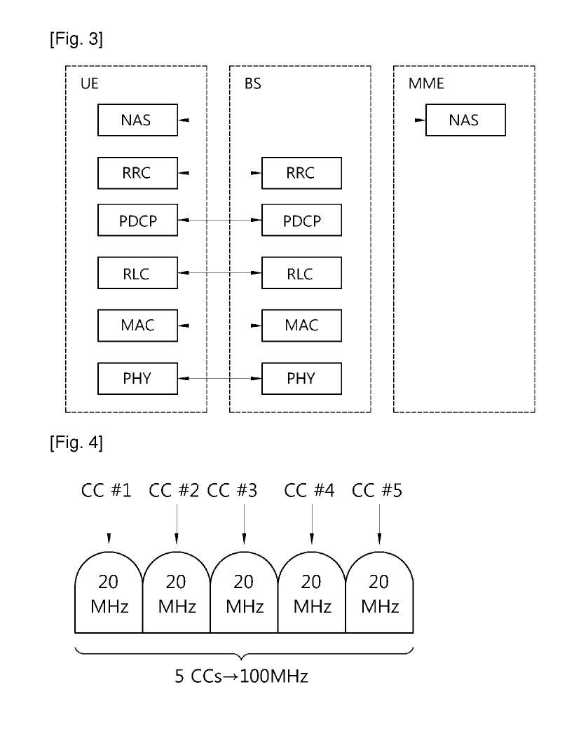

FIG. 2 is a diagram showing a radio protocol architecture for a user plane. FIG. 3 is a diagram showing a radio protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Between different PHY layers, i.e., a PHY layer of a transmitter and a PHY layer of a receiver, data are transferred through the physical channel. The physical channel may be modulated using an orthogonal frequency division multiplexing (OFDM) scheme, and may utilize time and frequency as a radio resource.

Functions of the MAC layer include mapping between a logical channel and a transport channel and multiplexing/de-multiplexing on a transport block provided to a physical channel over a transport channel of a MAC service data unit (SDU) belonging to the logical channel. The MAC layer provides a service to a radio link control (RLC) layer through the logical channel.

Functions of the RLC layer include RLC SDU concatenation, segmentation, and re-assembly. To ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides error correction by using an automatic repeat request (ARQ).

Functions of a packet data convergence protocol (PDCP) layer in the user plane include user data delivery, header compression, and ciphering. Functions of a PDCP layer in the control plane include control-plane data delivery and ciphering/integrity protection.

A radio resource control (RRC) layer is defined only in the control plane. The RRC layer serves to control the logical channel, the transport channel, and the physical channel in association with configuration, reconfiguration and release of radio bearers (RBs).

An RB is a logical path provided by the first layer (i.e., the PHY layer) and the second layer (i.e., the MAC layer, the RLC layer, and the PDCP layer) for data delivery between the UE and the network.

The setup of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

As disclosed in 3GPP TS 36.211 V8.7.0, the 3GPP LTE classifies physical channels into a data channel, i.e., a physical downlink shared channel (PDSCH) and a physical uplink shared channel (PUSCH), and a control channel, i.e., a physical downlink control channel (PDCCH), Physical Control Format Indicator Channel (PCFICH), Physical Hybrid-ARQ Indicator Channel (PHICH) and a physical uplink control channel (PUCCH).

Now, a multiple carrier system will be disclosed.

A 3GPP LTE system supports a case where a downlink bandwidth and an uplink bandwidth are set differently under the premise that one component carrier (CC) is used. The CC is defined with a center frequency and a bandwidth. This implies that the 3GPP LTE is supported only when the downlink bandwidth and the uplink bandwidth are identical or different in a situation where one CC is defined for each of a downlink and an uplink. For example, the 3GPP LTE system supports up to 20 MHz and the uplink bandwidth and the downlink bandwidth may be different from each other, but supports only one CC in the uplink and the downlink.

Spectrum aggregation (or bandwidth aggregation, also referred to as carrier aggregation) supports a plurality of CCs. The spectrum aggregation is introduced to support an increasing throughput, to prevent a cost increase caused by using a broadband radio frequency (RF) element, and to ensure compatibility with legacy systems.

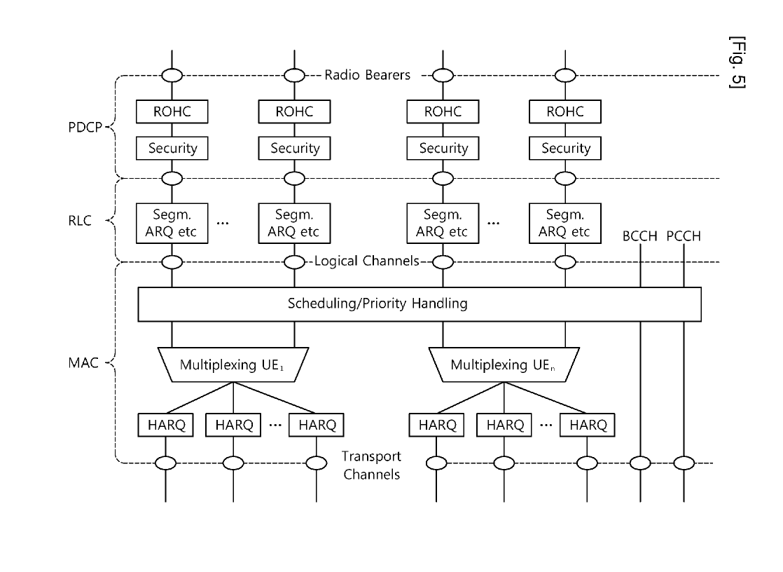

FIG. 4 shows an example of multiple carriers. There are five CCs, i.e., CC #1, CC #2, CC #3, CC #4, and CC #5, each of which has a bandwidth of 20 MHz. Therefore, if the five CCs are allocated in a granularity of a CC unit having the bandwidth of 20 MHz, a bandwidth of up to 100 MHz can be supported.

The bandwidth of the CC or the number of the CCs are exemplary purposes only. Each CC may have a different bandwidth. The number of downlink CCs and the number of uplink CCs may be identical to or different from each other.

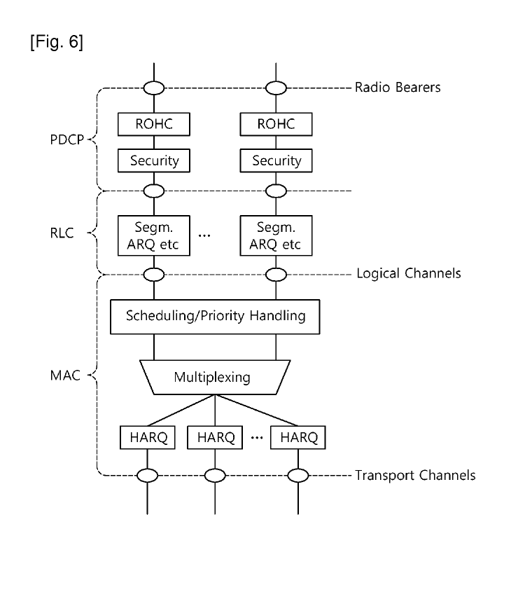

FIG. 5 shows a second-layer structure of a BS for multiple carriers. FIG. 6 shows a second-layer structure of a UE for multiple carriers.

A MAC layer can manage one or more CCs. One MAC layer includes one or more HARQ entities. One HARQ entity performs HARQ on one CC. Each HARQ entity independently processes a transport block on a transport channel. Therefore, a plurality of HARQ entities can transmit or receive a plurality of transport blocks through a plurality of CCs.

One CC (or a CC pair of a downlink CC and an uplink CC) may correspond to one cell. When a synchronous signal and system information are provided by using each downlink CC, it can be said that each downlink CC corresponds to one serving cell. When the UE receives a service by using a plurality of downlink CCs, it can be said that the UE receives the service from a plurality of serving cells.

The BS can provide the plurality of serving cells to the UE by using the plurality of downlink CCs. Accordingly, the UE and the BS can communicate with each other by using the plurality of serving cells.

A cell may be classified into a primary cell and a secondary cell. The primary cell which is always activated is a cell used for network entry such as a RRC connection establishment, RRC connection re-establishment, etc. A secondary cell may be activated or inactivated by the primary cell or a specific condition. The primary cell may be configured with a pair of DL CC and UL CC. The secondary cell may be configured with a pair of DL CC and UL CC or a DL CC only. Serving cells include one or more primary cells and zero or more secondary cells.

Next, a power headroom reporting will be disclosed.

To mitigate interference due to UL transmission, a transmit power of a UE needs to be adjusted. If the transmit power of the UE is too low, the BS barely receive UL data. If the transmit power of the UE is too high, the UL transmission may give too much interference to other UE's transmission.

A power headroom reporting procedure is used to provide the serving BS with information about the difference between the nominal UE maximum transmit power and the estimated power for UL-SCH transmission. RRC controls the power headroom reporting by configuring the two timers, a periodic timer and prohibit timer, and by signalling a pathloss threshold which sets the change in measured downlink pathloss to trigger the power headroom reporting.

According to the section 5.1.1 of 3GPP TS 36.213 V8.8.0 (2009-09) “Evolved Universal Terrestrial Radio Access (E-UTRA); Physical layer procedures (Release 8)”, a power headroom valid for subframe i is defined by:

MathFigure 1

PH(i)=P_{CMAX}−{10 log₁₀(M_{PUSCH}(i))+P_{O}_{_{—}}_{PUSCH}(j)+α(j)PL+Δ_{TF}(i)+f(i)} [Math.1]

where,

P_{CMAX} is a configured maximum UE transmitted power,

M_{PUSCH}(i) is the bandwidth of the PUSCH resource assignment expressed in number of resource blocks valid for subframe i,

PL is a downlink pathloss estimate calculated in the UE, and

P_{O}_{_{—}}_{PUSCH}(j), α(j), Δ_{TF}(j) and f(i) are parameters obtained from higher layer signaling.

A power headroom report (PHR) may be triggered if any of the following events occur:
a prohibit timer expires or has expired and the path loss has changed more than the pathloss threshold since the transmission of a PHR when UE has UL resources for new transmission;
a periodic timer expires;
upon configuration or reconfiguration of the power headroom reporting functionality by upper layers, which is not used to disable the function.

If the UE has UL resources allocated for new transmission for this TTI:
if it is the first UL resource allocated for a new transmission since the last MAC reset, start the periodic timer;
if the power headroom reporting procedure determines that at least one PHR has been triggered since the last transmission of a PHR or this is the first time that a PHR is triggered, and;
if the allocated UL resources can accommodate a PHR MAC control element plus its subheader as a result of logical channel prioritization:
obtain the value of the power headroom from the physical layer;
instruct the Multiplexing and Assembly procedure to generate and transmit a PHR MAC control element based on the value reported by the physical layer;
start or restart the periodic timer;
start or restart the prohibit timer;
cancel all triggered PHR(s).

The power headroom is transmitted as a MAC control element.

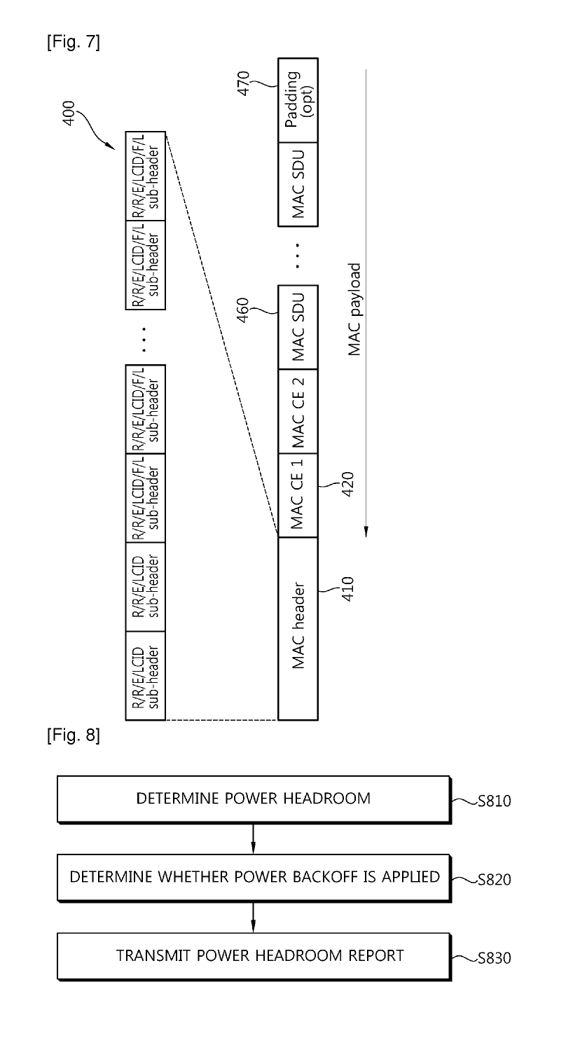

FIG. 7 shows a structure of a MAC PDU in 3GPP LTE.

A MAC Protocol Data Unit (PDU) 400 includes a MAC header 410, zero or more MAC control elements (CEs) 420, zero or more MAC service data units (SDUs) 460 and optionally padding bits 470. Both the MAC header 410 and the MAC SDUs 460 are of variable sizes. The MAC SDUs 460 is a data block provided from a higher layer (e.g., an RLC layer or an RRC layer) of a MAC layer. The MAC CE 420 is used to deliver control information of the MAC layer such as a BSR.

The MAC PDU header 410 includes one or more subheaders 411. Each subheader corresponds to either a MAC SDU, a MAC CE or padding bits.

The subheader 411 includes six header fields R/R/E/LCID/F/L but for the last subheader in the MAC PDU 400 and for fixed sized MAC CEs. The last subheader in the MAC PDU 410 and subheaders for fixed sized MAC CEs include solely of the four header fields R/R/E/LCID. A subheader corresponding to the padding bits includes four header fields R/R/E/LCID.

Descriptions on each field are as follows.
R (1 bit): A reserved field.
E (1 bit): An extended field. It indicates whether there are F and L fields in a next field.
LCID (5 bit): A logical channel ID field. It indicates a type of the MAC CE or a specific logical channel to which the MAC SDU belongs.
F (1 bit): A format field. It indicates whether a next L field has a size of 7 bits or 15 bits.
L (7 or 15 bit): A length field. It indicates a length of the MAC CE or MAC SDU corresponding to the MAC sub-header.

The F and L fields are not included in a MAC sub-header corresponding to a fixed-sized MAC CE.

Now, the proposed transmit power regulation and power headroom reporting will be described.

In order to reduce influence of a radio frequency (RF) electromagnetic wave having an effect on human body, it is strictly regulated by the authority concerned in each region such that transmit power of a portable radio device does not exceed a specific value.

An RF energy amount absorbed by the human body is generally measured by using an index called a specific absorption rate (SAR). The SAR is defined as a power amount absorbed to a unit mass per unit time. In United States, the FCC requires that phones sold have a SAR level at or below 1.6 watts per kilogram (W/kg) taken over a volume containing a mass of 1 gram of tissue. In European Union, CENELEC specifies SAR limits within the EU, following IEC standards. For mobile phones, and other such hand-held devices, the SAR limit is 2 W/kg averaged over 10 g of tissue (IEC 62209-1). For Magnetic Resonance Imaging the limits (described in IEC 60601-2-33) are slightly more complicated.

In a wireless communication system, transmit power of a UE is determined by a command of a BS. In addition, maximum transmit power that can be used by the UE is limited by a value determined by the BS.

However, if the UE uses a plurality of RATs simultaneously, transmit power of the RAT is regulated individually. For example, transmit power for LTE and transmit power for GSM are determined independently from each other.

Therefore, if the UE simultaneously uses another RAT (e.g., UTRAN or GSM) together with LTE, a total transmit power value (i.e., a total sum of transmit power of each RAT) of the UE may exceed a value allowed for the SAR.

In order to solve the aforementioned problem, if the total transmit power exceeds a maximum transmit power limit due to the simultaneous use of the plurality of RATs, it is proposed that the UE performs power backoff in which power is arbitrarily regulated so that the transmit power is less than or equal to an allowed value, and reports the power backoff to the BS.

The maximum transmit power limit may imply a maximum transmit power value which is an upper limit value allowed to the UE due to the SAR regulation.

The maximum transmit power limit may imply a maximum transmission power value when an inter-modulation product resulted from simultaneous transmission of a plurality of RATs does not exceed a threshold.

FIG. 8 is a flowchart showing a power headroom reporting method according to an embodiment of the present invention.

A UE determines a power headroom for each serving cell (S810). Let P_{CMAX,c} be a configured UE transmit power in subframe i for serving cell c. Based the P_{CMAX,c}, a power headroom in subframe i for serving cell c can be determined as shown in equation 1.

The UE determines whether power backoff is applied (S820). The UE can apply the power backoff when total transmit power exceeds a maximum transmit power limit. The power backoff can be applied at the occurrence of data transmission using a plurality of RATs, for example, when transmission of a UE that uses another RAT occurs while performing transmission of a UE that uses LTE. The power backoff can be applied when transmission of a UE starts by using another RAT for a voice service while the UE performs transmission by using LTE for data transmission. The power backoff can be applied when transmission starts by using LTE for data transmission while the UE performs transmission by using another RAT for the voice service. The power backoff can be applied when the UE arbitrarily regulates transmit power of the RAT.

The UE transmits a power headroom report (PHR) to the BS (S830). The PHR may include information on a power headroom, a backoff indicator, and P_{CMAX,c}. The backoff indicator indicates whether the power backoff is applied. The PHR can be transmitted as a MAC message or an RRC message.

The BS can know that the UE arbitrarily regulates the transmit power, and can more accurately know about available transmit power that can be used by the UE in uplink transmission. Therefore, improved link adaptation can be provided to the UE.

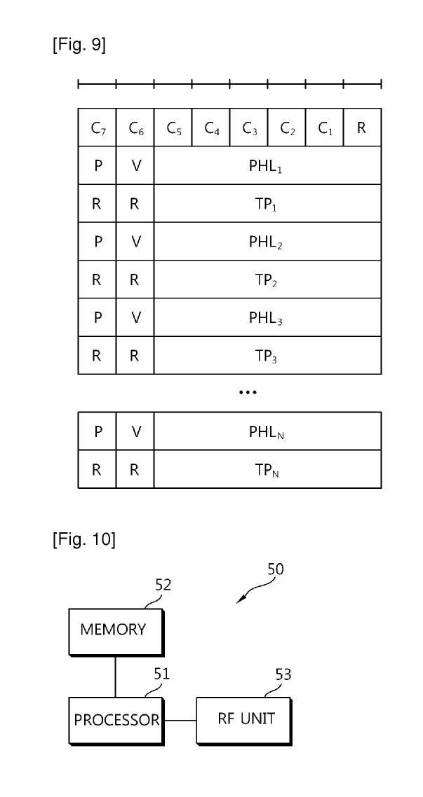

FIG. 9 is an example of MAC CE for PHR according to an embodiment of the present invention. The MAC CE for PHR can be identified by a MAC PDU subheader with LCID corresponding to the MAC CE for PHR.

The MAC CE includes a PH per serving cell and followed by an octet containing the associated P_{CMAX,c} (if reported). Then follows in ascending order based on the cell index of serving cells with a PH and the associated P_{CMAX,c} (if reported).

The fields in the PHR can be defined as follows:
Cᵢ: this field indicates the presence of a PH for the secondary cell with the cell index i. The Cᵢ field set to “1” indicates that a PH for the secondary cell with the cell index i is reported. The Cᵢ field set to “0” indicates that a PH for the secondary cell with cell index i is not reported;
R: reserved bit, set to “0”;
V: this field indicates if the PH value is based on a real transmission or a reference format. Furthermore, V=0 indicates the presence of the associated P_{CMAX,c}, and V=1 indicates that the associated P_{CMAX,c} is omitted;
PHLₙ: this field indicates the power headroom level (PHL) for n-th serving cell, where n=1, . . . N. For the primary cell, n=1 and for zero or more secondary cells, n=2, . . . , N. Each PHL indicates the value of the corresponding PH.
P: this field indicates whether the UE applies power backoff due to power management. The UE may set P=1 if the corresponding P_{CMAX,c} would have had a different value if no power backoff due to power management had been applied;
TPₙ: if present, this transmit power (TP) field contains the P_{CMAX,c} used for calculation of the preceding PH.

FIG. 10 is a block diagram showing an apparatus for implementing an embodiment of the present invention. The apparatus may be a part of a UE.

An apparatus 50 includes a processor 51, a memory 52, and a radio frequency (RF) unit 53. The memory 52 is coupled to the processor 51, and stores a variety of information for driving the processor 51. The RF unit 53 is coupled to the processor 51, and transmits and/or receives a radio signal. The processor 51 implements the proposed functions, processes and/or methods. The processor 51 may perform operations of UE according to the embodiment of FIG. 8.

The processor may include application-specific integrated circuit (ASIC), other chipset, logic circuit and/or data processing device. The memory may include read-only memory (ROM), random access memory (RAM), flash memory, memory card, storage medium and/or other storage device. The RF unit may include baseband circuitry to process radio frequency signals. When the embodiments are implemented in software, the techniques described herein can be implemented with modules (e.g., procedures, functions, and so on) that perform the functions described herein. The modules can be stored in memory and executed by processor. The memory can be implemented within the processor or external to the processor in which case those can be communicatively coupled to the processor via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1. A method of reporting a power headroom in a wireless communication system, the method comprising:
determining, by a user equipment, a power headroom based on a configured transmit power; and
transmitting, by the user equipment, a power headroom report to a base station, the power headroom report including a power headroom level indicating the power headroom and a backoff indicator indicating whether the user equipment applies power backoff due to power management.

2. The method of claim 1, wherein the power headroom report further includes a transmit power field indicating the configured transmit power.

3. The method of claim 2, wherein the backoff indicator is set to one if the transmit power field would have had a different value if no power backoff due to power management had been applied.

4. The method of claim 2, wherein the power headroom report further includes a presence field indicating the presence of the transmit power field.

5. The method of claim 1, wherein a plurality of power headrooms are determined for a plurality of serving cells.

6. The method of claim 5, wherein the power headroom report includes a plurality of power headroom levels and a plurality of backoff indicators, each of the plurality of power headroom levels indicating each power headroom for each of the plurality of serving cells.

7. An apparatus of reporting a power headroom in a wireless communication system, the apparatus comprising:
a radio frequency unit configured to transmit and receive a radio signal; and
a processor operatively coupled with the radio frequency unit and configured to:
determine a power headroom based on a configured transmit power; and
transmit a power headroom report to a base station, the power headroom report including a power headroom level indicating the power headroom and a backoff indicator indicating whether the user equipment applies power backoff due to power management.

8. The apparatus of claim 7, wherein the power headroom report further includes a transmit power field indicating the configured transmit power.

9. The apparatus of claim 8, wherein the backoff indicator is set to one if the transmit power field would have had a different value if no power backoff due to power management had been applied.

10. The apparatus of claim 8, wherein the power headroom report further includes a presence field indicating the presence of the transmit power field.

11. The apparatus of claim 7, wherein a plurality of power headrooms are determined for a plurality of serving cells.

12. The apparatus of claim 11, wherein the power headroom report includes a plurality of power headroom levels and a plurality of backoff indicators, each of the plurality of power headroom levels indicating each power headroom for each of the plurality of serving cells.
